(19) United States
(12) Patent Application Publication
(10) Pub. No.: US 2011/0051042 A1
(43) Pub. Date: Mar. 3, 2011

(54) LIQUID CRYSTAL DISPLAY DEVICE

(76) Inventors: Katsunari SATO, Toda (JP); Yoshiharu Yamashita, Yokohama (JP)

(21) Appl. No.: 12/814,578

(22) Filed: Jun. 14, 2010

(30) Foreign Application Priority Data
Aug. 31, 2009 (JP) 2009-199605
Aug. 31, 2009 (JP) 2009-199611

(51) Int. Cl. G02F 1/13357

(52) U.S. Cl. 349/64; 349/62

(57) ABSTRACT

A liquid crystal display device is provided in which, even when divided light guide plate blocks are thermally expanded or contracted as a result of a temperature change, the generation of clearances and mechanical deformations between such divided light guide plate blocks is prevented, making it possible to reduce the brightness unevenness of the liquid crystal display device. To realize the above feature, light guide plate blocks are arranged such that one or two of them are arranged in each horizontal row with only an upper side of each light guide plate block fixed to a chassis and, furthermore, such that the upper side fixed to the chassis of each light guide plate block is based on a center in the horizontal direction of the liquid crystal display panel so as to reduce the effects of thermal expansion and contraction of each light guide plate block.

### BACKGROUND OF THE INVENTION

(1) Field of the Invention

The present invention relates to a liquid crystal display device, particularly, a liquid crystal display device using a backlight device which converts, using light guide plates, the illumination light outputted from light emitting diodes into surface light and outputs the surface light to a liquid crystal panel.

(2) Description of the Related Art

There have been edge-light (side-light) type backlight devices in which light is supplied from a side and direct type backlight devices in which light is supplied from behind (from a rear side). In edge-light type backlight devices, light emitted from a primary light source, for example, a cold cathode fluorescent lamp (CCFL) or a light emitting diode (LED) is converted into surface light using a light guide plate formed of a highly scattering optical transmission (HSOT) polymer or a transparent material. Such edge-light type backlight device is widely used in liquid crystal display device. Furthermore, so-called tandem-type backlight device in which plural light guide plates and light source combinations is two-dimensionally arranged so as to secure a relatively wide emission area have also been proposed.

Tandem-type backlight systems including two-dimensionally arranged plural light guide plates are disclosed, for example, in Japanese Patent Publication No. 3373427 and Japanese Patent Application Laid-Open No. 2006-286638.

### SUMMARY OF THE INVENTION

In recent years, liquid crystal display devices, while being made thinner, have been growing larger in screen size. The tandem-type backlight device described above is, compared with other types of backlight device, advantageous in making liquid crystal display device thinner and larger in screen size.

In a tandem-type backlight device, light fluxes outputted from primary light sources (hereinafter generically referred to as “LED” as being representative of primary light sources) is inputted to light guide plates formed of transparent material (for example, acrylic resin, polycarbonate resin, or cycloolefin resin). The light fluxes inputted to the light guide plate are reflected at the reflection surface of reflection sheet provided at the rear side of the light guide plate and also at the diffuse reflection patterns provided on the light guide plate, and are then outputted as surface light via a diffusion sheet disposed over the output surface of the light guide plate. The light guide plate are shaped with their thickness gradually decreasing along the direction from the LED side toward their light output side. The diffuse reflection patterns are provided in an arrangement in which they are denser where they are more away from the LEDs.

A tandem-type backlight device is configured using such light guide plates and LEDs arranged in plural blocks (light guide plate blocks). In a tandem-type backlight device including plural light guide plate blocks, however, a clearance and a mechanical deformation can be generated between light guide plate blocks because of differences between them as to thermal expansion or contraction dependent on, for example, their materials, dimensions, and shapes. Such the clearance and the deformation cause brightness unevenness (differences in brightness level) in the output light of the backlight device or on the screen of the liquid crystal display device. The brightness unevenness can be eliminated by increasing the distance between the light guide plate and the diffusion sheet, but doing so increases the thickness of the backlight device.

The present invention has been made in view of the above problem and it is an object of the invention to provide a liquid crystal display device in which the generation of the clearance and the mechanical deformation between light guide plate blocks resulting from their thermal expansions or contractions caused by temperature changes is reduced.

According to a first aspect of the present invention, a liquid crystal display device for displaying an image using a liquid crystal panel is provided which comprises: a plurality of light sources which are arranged in a horizontal direction to be spaced apart by a predetermined distance and which emit light downwardly; a plurality of light guide plate blocks to which the light emitted from the plurality of light sources is downwardly incident and which output the incident light to the liquid crystal panel as surface light; and a chassis which fixes the plurality of light sources and the plurality of light guide plate blocks from behind. In the liquid crystal display device: the plurality of light guide plate blocks are arranged along a vertical direction of the liquid crystal display device, each of the plurality of light guide plate blocks having a rectangular shape longitudinally extending along a horizontal direction of the liquid crystal display device; and each of the plurality of light guide plate blocks is fixed, at a portion thereof corresponding to a center in the horizontal direction of the liquid crystal display device, to the chassis, and a clearance is provided at each end in the horizontal direction of each of the plurality of light guide plate blocks.

Preferably, in the liquid crystal display device, a rear side of each of the plurality of horizontal rows including the plurality of light guide plate blocks is entirely covered by a reflection sheet.

According to a second aspect of the present invention, a liquid crystal display device for displaying an image using a liquid crystal panel is provided which comprises: a plurality of light sources which are arranged in a horizontal direction to be spaced apart by a predetermined distance and which emit light downwardly; a plurality of light guide plate blocks to which the light emitted from the plurality of light sources is downwardly incident and which output the incident light as surface light; a diffusion sheet which diffuses light coming from the plurality of light guide plate blocks and outputs the diffused light to the liquid crystal panel; and a chassis which fixes the plurality of light sources and the plurality of light guide plate blocks from behind. In the liquid crystal display device: the plurality of light guide plate blocks are arranged along a vertical direction of the liquid crystal display device, each of the plurality of light guide plate blocks having a rectangular shape longitudinally extending along a horizontal direction of the liquid crystal display device; and each of the plurality of light guide plate blocks is provided, on a rear side thereof, with a reflection sheet support member for supporting the light guide plate block from behind, the reflection sheet support member having a projection formed integrally therewith for supporting the diffusion sheet from behind.

In the liquid crystal display device, each of the reflection sheet support member and the projection may have a white surface.

In the liquid crystal display device, the reflection sheet support member may further have a fixing part formed integrally therewith for fixing another light guide plate block provided adjacently below the light guide plate block supported by the reflection sheet support member, the fixing part having, on a front side thereof, the projection formed integrally therewith.

According to a third aspect of the present invention, a liquid crystal display device for displaying an image using a liquid crystal panel is provided which comprises: a plurality of light sources which are arranged in a horizontal direction to be spaced apart by a predetermined distance and which emit light downwardly; a plurality of light guide plate blocks to which the light emitted from the plurality of light sources is downwardly incident and which output the incident light as surface light; a diffusion sheet which diffuses light coming from the plurality of light guide plate blocks and outputs the diffused light to the liquid crystal panel; and a chassis which fixes the plurality of light sources and the plurality of light guide plate blocks from behind. In the liquid crystal display device: the plurality of light guide plate blocks are arranged along a vertical direction of the liquid crystal display device, each of the plurality of light guide plate blocks having a rectangular shape longitudinally extending along a horizontal direction of the liquid crystal display device; and each of the plurality of light guide plate blocks is provided, on a rear side thereof, with a reflection sheet support member for supporting the light guide plate block from behind, the reflection sheet support member having a fixing part formed integrally therewith for fixing another light guide plate block provided adjacently below the light guide plate block supported by the reflection sheet support member.

In the liquid crystal display device, each of the reflection sheet support member and the projection may be configured to reflect light at a surface thereof.

In the liquid crystal display device: the reflection sheet support member may further have a projection formed integrally therewith for supporting the diffusion sheet from behind, the projection being formed integrally with the fixing part.

In the liquid crystal display device, the plurality of light guide plate blocks are arranged in two vertical columns arranged side by side in a horizontal direction of the liquid crystal display device.

According to the present invention, a surface light source unit and a liquid crystal display device using the same can be provided in which clearances or mechanical deformations generated between divided blocks when such blocks are thermally expanded or contracted as a result of a temperature change are reduced. Therefore, unevenness of the light outputted from the surface light source unit and the brightness unevenness of the liquid crystal display device can be reduced.

The present invention can also provide a liquid crystal display device in which no clearance is formed between divided blocks so as not to allow mechanical deformations to be generated between such blocks when such blocks are thermally expanded or contracted. It is therefore possible to reduce the distance between the surface light source and a diffusion sheet and thereby reduce the thickness of the liquid crystal display device.

### BRIEF DESCRIPTION OF THE DRAWINGS

FIG. 1 is a diagram for describing a light guide plate block used in a backlight device according to an embodiment of the present invention;

FIGS. 2A to 2G are diagrams for describing an example structure of a light guide plate block according to an embodiment of the present invention;

FIGS. 3A and 3B are diagrams for describing the shifting, caused by temperature changes, of a row of light guide plate blocks according to the present invention relative to the corresponding LEDs;

FIG. 4 is a partial sectional view of a backlight device included in a liquid crystal display device according to an embodiment of the present invention;

FIG. 5 is a partial sectional view of the backlight device and the liquid crystal panel included in the liquid crystal display device;

FIGS. 6A to 6D is a diagram for describing effects of the thermal expansion and contraction of a light guide plate caused by temperature changes in an arrangement where an LED is provided on a side (left or right) of each light guide plate;

FIG. 7 is a diagram for outlining an example overall structure of the liquid crystal display device according to an embodiment of the present invention;

FIG. 8 is a partial sectional view of a liquid crystal display device according to the present invention in which the fixing part 405, pin mold 502, and reflection sheet guide 404 are combined into an integral structure; and

FIGS. 9A to 9C are diagrams, including partial sectional views, of an example fixing part integrated with a reflection sheet guide included in a liquid crystal display device according to the present invention.

### DETAILED DESCRIPTION OF THE EMBODIMENTS

Embodiments of the present invention will be described below with reference to the accompanying drawings. In the accompanying drawings, identical components having identical functions are denoted by identical reference numerals, and their descriptions are omitted where appropriate to avoid duplication. Also, any enlarged view of a component drawn for use in relevant description may not represent the real dimensional proportions of the component and, moreover, different portions of the component may be drawn differently enlarged even along a same dimensional direction.

The directions such as front-rear (front-back), upper-lower (vertical), and left-right (horizontal) directions denoted by arrows in the accompanying drawings are as seen by a viewer facing the screen of a liquid crystal display device placed on a flat surface (desktop installation). This also applies to the descriptions associated with the accompanying drawings. In this specification, items, for example, power supply cords, wirings between circuit boards, and other miscellaneous parts irrelevant to the present invention are omitted in the description and drawings.

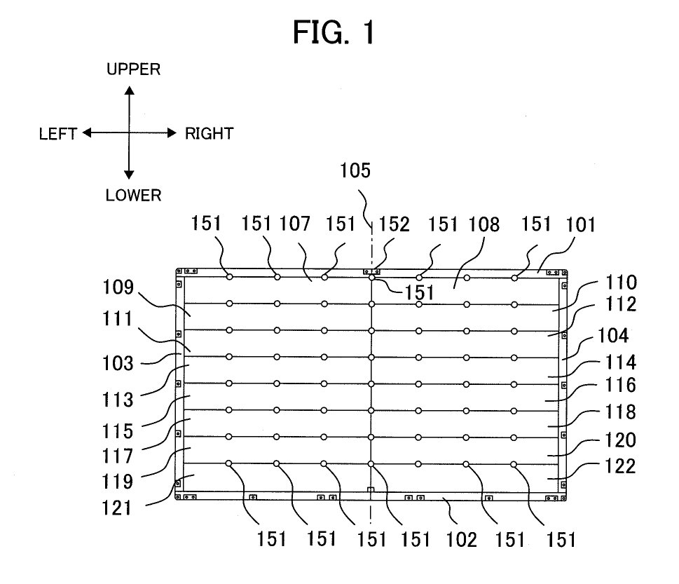

An embodiment of a backlight device according to the present invention will be described below with reference to FIG. 1. FIG. 1 is a diagram for describing a light guide plate block used in the backlight device of the present embodiment. The front-rear direction of the liquid crystal display device incorporating the backlight device corresponds to the depth direction of FIG. 1 with the deeper side of FIG. 1 corresponding to the rear side and the FIG. 1 surface side corresponding to the front side, respectively, of the liquid crystal display device installed for viewing. Components such as a liquid crystal panel, to be disposed on the front side of the light guide plate blocks are not illustrated in FIG. 1. In FIG. 1, reference numeral 101 denotes an upper frame; 102 a lower frame; 103 a left frame; 104 a right frame; 105 a center line indicating the center of the upper frame 101; 107 to 122 light guide plate blocks; and 151 and 152 fixing parts. The fixing parts 151 are small circular parts provided at upper and lower sides of each of the light guide plate blocks 107 to 120. In FIG. 1, to avoid complication, only some of them are denoted by their reference number. The fixing parts 152 will be described later.

The upper frame 101, lower frame 102, left frame 103, and right frame 104 are made of, for example, aluminum or iron. The light guide plate block is made of, for example, acrylic resin, polycarbonate resin, or cycloolefin resin.

As shown in FIG. 1, the light guide plate blocks 107 to 122 each have a rectangular shape with a horizontally extending longer side (extending along the horizontal direction of the liquid crystal display device). They are arranged in two columns with each column including eight vertically arranged light guide plate blocks (two columns and eight rows). Two light guide plate blocks, for example, 107 and 108 horizontally (laterally) arranged side by side in a same row are fixed, using the center line 105 as a positioning reference, to a chassis (not illustrated in FIG. 1) provided behind the light guide plate blocks 107 to 120 by fixing parts 151 and 152. The light guide plate blocks 107 and 120 are each fixed at their upper side to be in a state of being hung. A left-end portion of the light guide plate block 107 and a right-end portion of the light guide plate block 108 are not fixed by fixing parts 151 and 152, and there is a clearance between the left end (left side) of the light guide plate block 107 and the left frame 103 and also between the right end (right side) of the light guide plate block 108 and the right frame 104 so as to absorb thermal expansion of the light guide plate blocks 107 and 108, respectively. There is a clearance, which is smaller than that provided between each of the light guide plate blocks 107 and 108 and the corresponding side frame, between the light guide plates 107 and 108, or alternatively, the two light guide plate blocks are in close contact without any clearance between them.

Namely, in the present embodiment, the light guide plate blocks have greater latitude at their left or right end portions to accommodate thermal expansion or contraction (that is, they are arranged to be thermally expanded or contracted more at their portions corresponding to lateral outer portions of the liquid crystal display device than at their portions corresponding to lateral center portions of the liquid crystal display device).

Temperature changes, therefore, cause the light guide plate block 107 to expand or contract mainly in its portion toward its left end and the light guide plate block 108 to expand or contract mainly in its portion toward its right end.

A preferable arrangement of light guide plate blocks may include eight light guide plate blocks arranged in one column (one column and eight rows) with each of the eight light guide plate blocks being horizontally longitudinal and fixed at the center line 105. The light guide plate blocks can then thermally expand laterally outwardly and contract laterally inwardly on both sides of the center line 105.

When three or more light guide plate blocks are arranged in each row, it becomes necessary to provide, in addition to the two clearances to be provided at the left and right ends of the horizontal rows, two or more horizontally spaced-apart clearances for absorbing thermal expansion and contraction of the light guide plate blocks. This complicates the configuration of the light guide plate blocks. The light guide plate block configuration of the present embodiment shown in FIG. 1, on the other hand, is very simple with a clearance provided only at each side of each row.

Generally, the clearance between light guide plate blocks shows as a dark line on the screen, so that more clearances cause greater brightness unevenness possibly resulting in failure to meet optical specification requirements of the liquid crystal display device. In the case of the present embodiment shown in FIG. 1 including only two clearances (the smallest numerical clearances) at both ends of each row of light guide plate block, however, it will be easier to meet the optical specifications required of the liquid crystal display device.

In the case of the present embodiment shown in FIG. 1, the liquid crystal display device is assumed to have, for example, a 42-inch (diagonal) screen. It will be necessary to change the number of light guide plate blocks to be used according to the screen size involved.

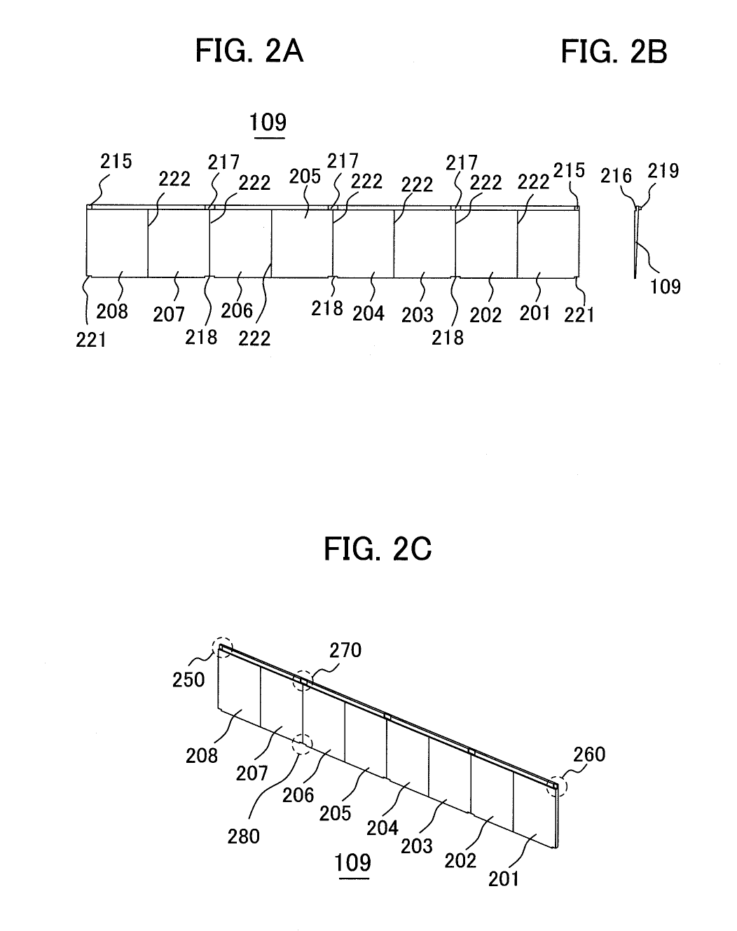

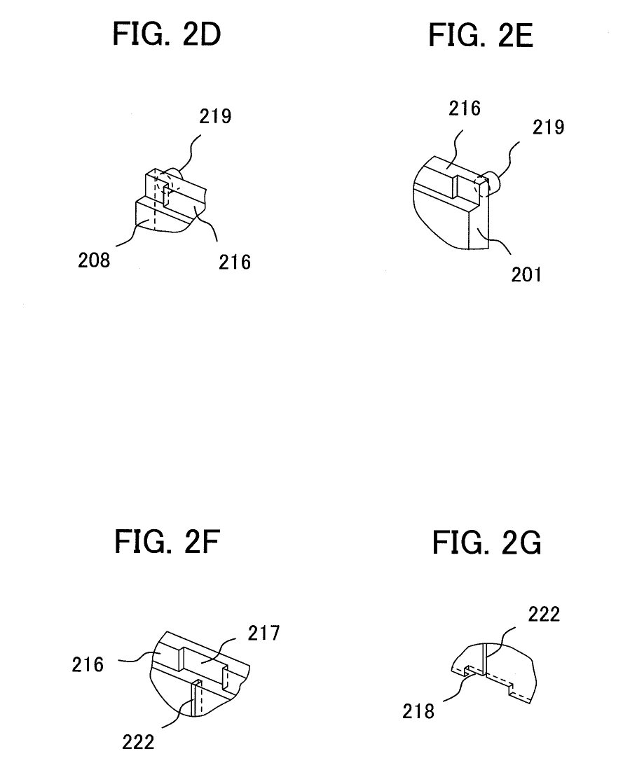

With reference to FIGS. 2A to 2G, the light guide plate block 109 among the light guide plate blocks 107 to 122 will be described in detail below. FIGS. 2A to 2G are diagrams for describing an example structure of a light guide plate block according to the present embodiment. In FIGS. 2A to 2G, reference numerals 201 to 208 denote light guide plates; each reference numeral 222 denotes a groove between adjacent ones of the light guide plates 201 to 208; reference numeral 216 denotes a concave portion of the light guide plate block 109 provided to receive the lower end of the light guide plate block 107 directly above the light guide plate block 109; reference numerals 215 denote concave portions for fixing use provided at both ends of the concave portion 216; each reference numeral 217 denotes a concave portion for fixing use provided inside the concave portion 216; each reference numeral 218 denotes a cutout portion for fixing use provided in the lower end portion of the light guide plate block 109; reference numerals 221 denote cutout portions for fixing use provided in lower end portions on both sides of the light guide plate block 109; and each reference numeral 219 denotes a positioning pin used to position the light guide plate block 109. The concave portions 215 and 217 and the cutout portions 218 and 221 for positioning use are provided in position ranges predetermined using the grooves 222 between the light guide plates 201 to 208 as positioning references. The positioning pins 219 are also provided in positions predetermined relative to both ends of the light guide plate block 109.

FIGS. 2A, 2B, and 2C are a front view, a side view, and a perspective view of the light guide plate block 109, respectively. FIGS. 2D, 2E, 2F, and 2G are enlarged views of circled portions 250, 260, 270, and 280 shown in FIG. 2C, respectively.

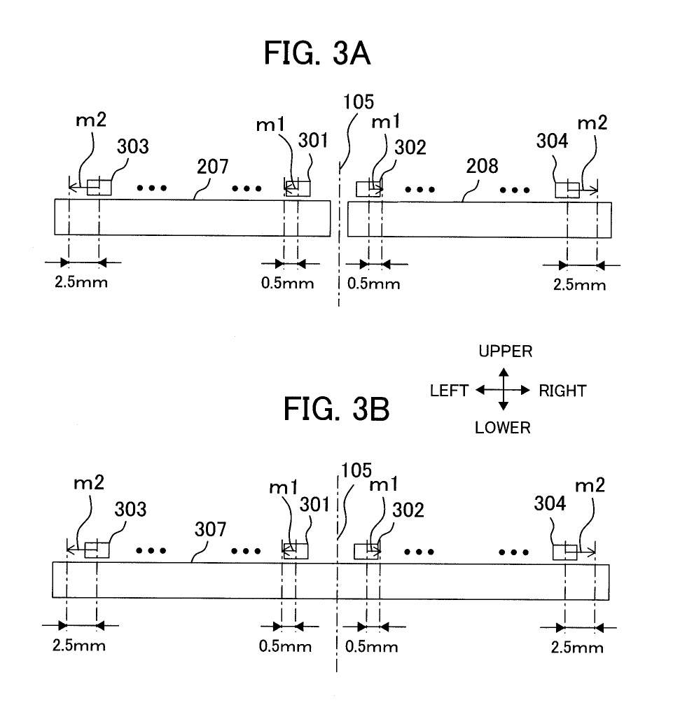

With reference to FIGS. 3A and 3B, the shifting of light guide plate blocks relative to corresponding LEDs caused by thermal expansion or contraction of the light guide plate blocks will be described. FIGS. 3A and 3B are diagrams for describing the shifting, caused by temperature changes, of a row of light guide plate blocks according to the present invention relative to the corresponding LEDs. FIG. 3A shows two light guide plate blocks arranged in one of the rows of light guide plate blocks described above with reference to FIG. 1 (for example, the light guide plate blocks 207 and 208 shown in FIG. 2A to 2G). FIG. 3B is for describing the shifting of a light guide plate block replacing, for example, the two light guide plate blocks arranged side by side in a row as shown in FIG. 3A. In FIGS. 3A and 3B, reference numeral 301 denotes an LED which corresponds to the light guide plate block 207 (or 307) and is disposed, in the lateral direction, closest to the center of the row (closest to the center line 105); reference numeral 303 denotes an LED which corresponds to the light guide plate block 207 (or 307) and is disposed, in the lateral direction, most leftwardly (farthest from the center line 105); reference numeral 302 denotes an LED which corresponds to the light guide plate block 208 (or 307) and is disposed, in the lateral direction, closest to the center of the row (closest to the center line 105); reference numeral 304 denotes an LED which corresponds to the light guide plate block 208 (or 307) and is disposed, in the lateral direction, most rightwardly (farthest from the center line 105); each symbol ml denotes an arrow representing the direction of shifting, caused by thermal expansion or contraction, of a light guide plate block relative to the LED 301 or LED 302; and reference numeral 307 denotes a light guide plate block.

LEDs 301 to 304 are mounted on printed circuit boards (not illustrated) provided behind (on the rear side of) the light guide plate blocks. For the light guide plate block 207, two printed circuit boards are horizontally arranged side by side. Like the light guide plate blocks, the printed circuit boards are discrete from those arranged above and below them (those arranged in other rows). They are manufactured using, for example, glass epoxy resin substrate as a base material and by applying known technology.

As shown in FIGS. 3A and 3B, the light guide plate blocks are fixed using the center line 105 as a positioning reference to be laterally expandable and contractible. For the present example, each light guide plate block is assumed to thermally expand, in its longitudinal direction (laterally or horizontally), 2.5 mm in an outermost portion and 0.5 mm in an innermost portion, and is also assumed to thermally expand, in the vertical direction, 0.6 mm.

The light guide plates are manufactured such that their optical performance can tolerate their thermal expansion and contraction assumed as described above.

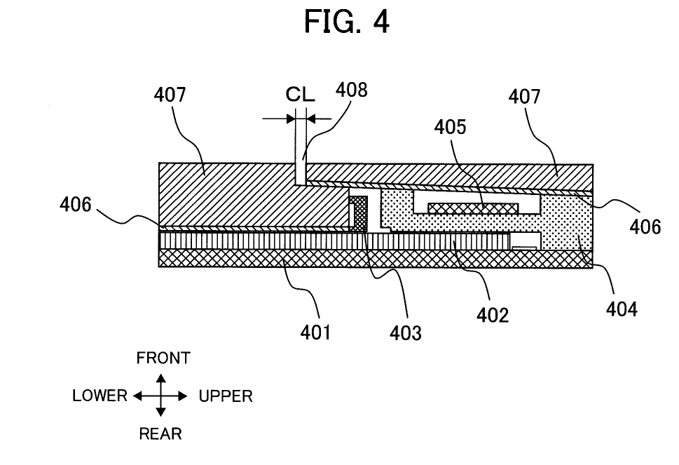

With reference to FIG. 4, the arrangement for absorbing the vertical shifting of each light guide plate block will be described below. FIG. 4 is a partial sectional view of a backlight device included in a liquid crystal display device according to an embodiment of the present invention. In FIG. 4, reference numeral 401 denotes a chassis; 402 a printed circuit board; 403 an LED; 404 a reflection sheet guide (reflection sheet support member) for supporting a reflection sheet; 405 a fixing part; 406 a reflection sheet; each 407 a light guide plate block; and 408 a clearance.

Referring to FIG. 4, first the printed circuit board 402 on which the LED 403 is mounted is fixed to the chassis 401; then the reflection sheet guide 404 is placed over (on the front side of) the printed circuit board 402 and is fixed with the fixing part 405 using a screw. The light guide plate block 407 is attached over (on the front side of) the reflection sheet 406. Whereas the light guide plate block 407 has an approximately right-triangular section with a front side being horizontally flat (parallel with the horizontal direction) and a rear side being inclined, the reflection sheet guide 404 has an approximately right-triangular section with a rear side being horizontally flat (parallel with the horizontal direction) and a front side which comes in contact with the reflection sheet 406 and the light guide plate block 407 being inclined. In this arrangement, the front sides of the chassis 401, printed circuit board 402 and light guide plate block 407 are kept in parallel with the horizontal direction.

The clearance CL is, for example, 0.6 mm.

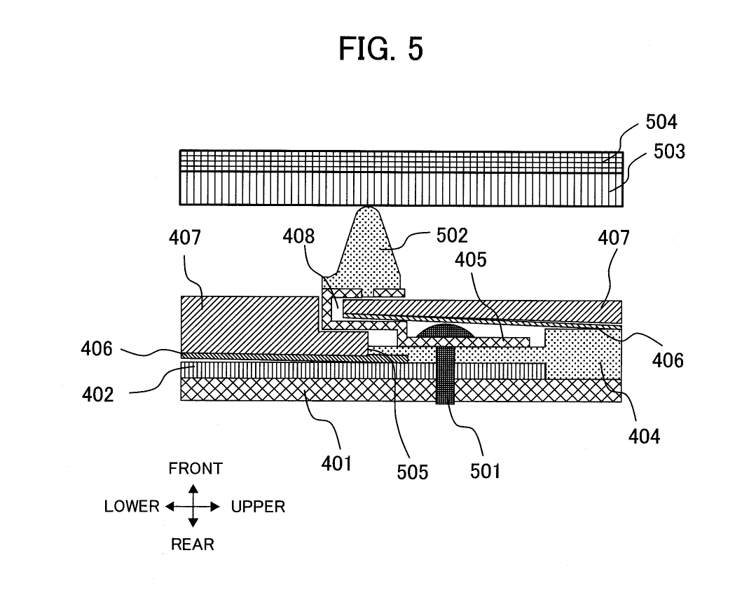

With reference to FIG. 5, an example part fixing structure of the liquid crystal display device according to the present embodiment will be described below. FIG. 5 is a partial sectional view of the backlight device and the liquid crystal panel included in the liquid crystal display device. Whereas FIG. 4 is a sectional view showing a section of an LED, FIG. 5 is a sectional view showing no section of any LED but showing sections of a light guide plate and a printed circuit board on which an LED is mounted. Namely, FIG. 5 showing a section of the backlight device different from the section shown in FIG. 4 does not show the LED 403, but it shows a liquid crystal panel 504 which is not shown in FIG. 4. In FIG. 5, reference numeral 501 denotes a fixing screw; 502 a pin mold placed over the fixing screw 501; 503 a diffusion sheet; and 504 a liquid crystal panel.

As done with reference to FIG. 4, a procedure for assembling (fitting) a light guide plate block according to the present embodiment will be described below with reference to FIG. 5, too.

First, the printed circuit board 402 on which an LED (see FIG. 4) is mounted is fixed to the front of the chassis 401 using, for example, screws. Next, the reflection sheet guide 404 is placed on the front of the printed circuit board 402, then the reflection sheet guide 404 is positioned and fixed with the fixing screw 501 while pressing, from the front side, the fixing part 405 attached with the pin mold 502. Subsequently, the reflection sheet 406 is placed over the front of the assembly thus prepared including the reflection sheet guide 404. The fixing part 405 is the same as the fixing part 152 described with reference to FIG. 1. The pin mold 502 is the same as the fixing part 151 described with reference to FIG. 1. The center of the fixing part 151 (fixing part 405) in the portion shown in FIG. 5 is located where it crosses the width center line 105 shown in FIG. 1 of the liquid crystal display device. The pin mold 502 is projecting on the front side to support the diffusion sheet 503 from behind.

The reflection sheet 406 is sized preferably such that it can be used also for two light guide plate blocks arranged longitudinally side by side in a row, for example, the light guide plate blocks 107 and 108 described with reference to FIG. 1. In the present embodiment, the single reflection sheet 406 is used for two light guide plate blocks horizontally arranged in each row, for example, the light guide plate blocks 107 and 108. The reflection sheet 406 used in such an arrangement can minimize the backlight brightness unevenness caused by light leakage resulting from the use of plural discrete light guide plates, for example, light leakage through boundaries, along the center line 105 (see FIG. 1), between light guide plate blocks or through the grooves 222 (see FIG. 2A) included in each light guide plate block.

The upper portion of each light guide plate block 407 is positioned in a clearance 505 formed below the reflection sheet guide 404. The lower portion of each light guide plate block 407 is inserted in a concave portion (bent portion) of the fixing part 405 to be fixed there. The clearance 408 formed at this time in the concave portion (bent portion) of the fixing part 405 serves to absorb downward thermal expansion of the light guide plate block 407. In this arrangement, an upper portion of the light guide plate block 407 is, together with the reflection sheet 406 and the printed circuit board 402, held between a pressing part formed by the concave portion (bent portion) of the fixing part 405 and the chassis 401. The lower portion of the light guide plate block 407, on the other hand, is inserted in the concave portion (bent portion) of the fixing part 405 without being pressed. Namely, the lower portion of the light guide plate block 407 is inserted in the concave portion (bent portion) of the fixing part 405 in a movable state. Thus, the lower portion of the light guide plate block 407 can move to absorb thermal expansion and contraction of the light guide plate block 407. The light guide plate block 407 is fixed in position by the positioning pins 219, not illustrated in FIGS. 4 and 5, as described with reference to FIGS. 2A to 2G.

The above procedure for installing the light guide plate block 407 is repeated for each row, beginning with the top row, then proceeding downwardly.

Subsequently, the diffusion sheet 503 is placed over the light guide plate blocks 407 such that the projection of each pin mold 502 comes in contact with the back (rear side) of the diffusion sheet 503 thereby determining the distance between the light guide plate blocks 407 and the diffusion sheet 503. The pin mold 502 is equivalent to the fixing part 151 shown in FIG. 1.

The fixing part 405 is made of metal, for example, iron to secure high reflectance. According to an embodiment of the present invention, the projection on the front side (on the liquid crystal panel side) of the fixing part 405 has a white surface so as to reflect light with high reflectance. Furthermore, a reflective coating may be applied to the projection as required. Allowing the pin mold 502 to reflect light efficiently makes it possible to efficiently guide the light outputted frontwardly from the light guide plate blocks 407 toward the liquid crystal panel.

The optical operation of the light guide device configured as described above will be described below. LEDs are provided above the light guide plate blocks 407. The LEDs emit light downward causing the light to be inputted to the light guide plate blocks 407. The light inputted to the light guide plate blocks 407 is, after undergoing reflection, refraction, and diffusion at the light guide plate blocks 407 as well as reflection by the reflection sheets 406, outputted as surface light toward the front side (the liquid crystal panel side). The surface light outputted from the light guide plate blocks 407 is inputted to the liquid crystal panel 504 after passing through the diffusion sheet 503 and a prism sheet, not illustrated. In the liquid crystal panel 504, light transmittance is controlled pixel by pixel thereby allowing the light inputted to the liquid crystal panel 504 to be spacially modulated to display an image.

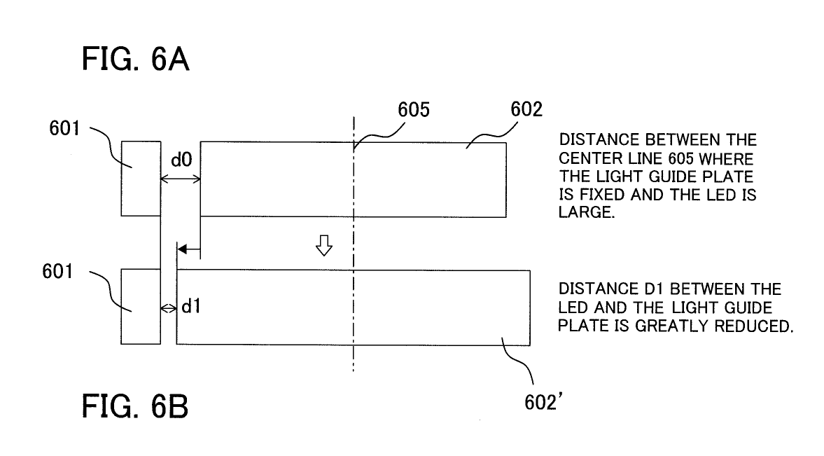

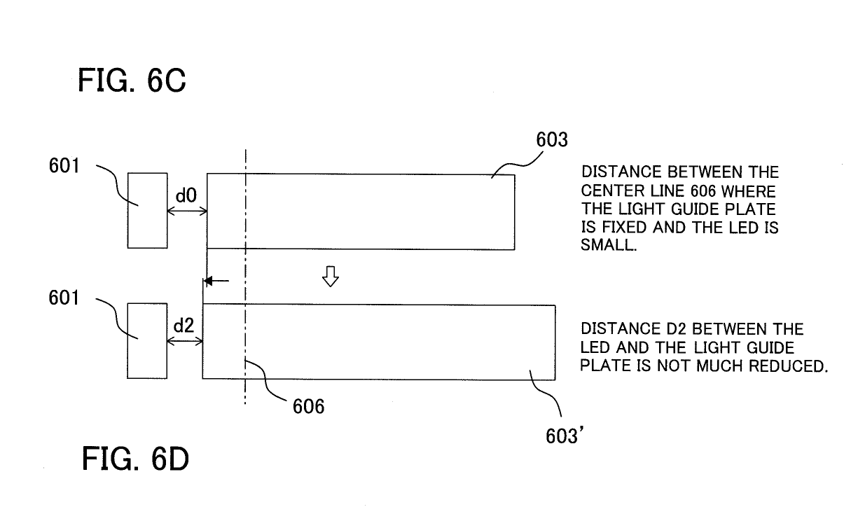

A liquid crystal display device according to an embodiment of the present invention will be described below with reference to FIGS. 6A to 6D. FIGS. 6A to 6D is a diagram for describing effects of the thermal expansion and contraction of a light guide plate caused by temperature changes in an arrangement where an LED is provided on a side (left or right) of each light guide plate. In FIGS. 6A to 6D, reference numeral 601 denotes an LED; 602 a light guide plate fixed at a position on a center line 605; 602′ the light guide plate 602 in a thermally expanded state; 603 a light guide plate fixed at a position near the LED 601 (on a center line 606; and 603′ the light guide plate 603 in a thermally expanded state.

As shown in FIG. 6A, when the light guide plate 603 is fixed at a center thereof (on the center line 605), the distance between the LED 601 and where the light guide plate 602 is fixed (on the center line 605) is large. When the light guide plate 602 fixed in this manner is thermally expanded, it laterally expands equally to both sides as shown in FIG. 6B. This causes the distance between the light guide plate 602′ and the LED 601 to be reduced from d0 (see FIG. 6A) to d1 (see FIG. 6B). When the light guide plate 602′ is thermally contracted, the distance increases. Large changes in the distance between the light guide plate 602 or 602′ and the LED 601 largely changes the amount of light incident to the light guide plate to cause great brightness unevenness of the backlight device or liquid crystal display device.

When the light guide plate 603 is fixed at a position near the LED 601 (on the center line 606 as shown in FIG. 6C, the amount of lateral thermal expansion on the LED 601 side of the light guide plate 603 is small as shown in FIG. 6D. Therefore, the distance between the light guide plate 603 and the LED 601 does not change much. Namely, the difference between distance d0 (see FIG. 6C) and distance d2 (see FIG. 6D) is small. Similarly, when the light guide plate 603′ is thermally contracted, the amount of lateral thermal contraction on the LED 601 side of the light guide plate 603′ is small, i.e. the distance between the light guide plate 603′ and the LED 601 does not change much. Hence, the amount of light incident to the light guide plate does not change much.

As described above with reference to FIGS. 6A to 6D, the smaller the distance between the LED and the position where the light guide plate is fixed, the smaller the brightness unevenness caused by temperature changes. According to the embodiments described with reference to FIG. 2A to FIG. 5 of the present invention, the light guide plate blocks are each fixed at their upper portions (for example, using the positioning pins 219 and concave portions 215 and 217 for fixing use, and the fixing parts 405 shown in FIGS. 4 and 5). Namely, each light guide plate block is fixed on a horizontal line along the concave portion 216 for fixing use shown in FIGS. 2A to 2G. For each light guide plate block, plural LEDs are laterally arranged above the light guide plate block. The light emitted from the LEDs is downwardly inputted to the light guide plate block and is, after having its direction changed by a reflection sheet and the light guide plate block, outputted frontwardly from the light guide plate block.

Thus, according to the above embodiments, the effects of thermal expansion and contraction in the vertical direction of each light guide plate block caused by temperature changes on the distance between the light guide plate block and the corresponding LEDs is small, so that the brightness unevenness of the backlight device and the liquid crystal display device is small.

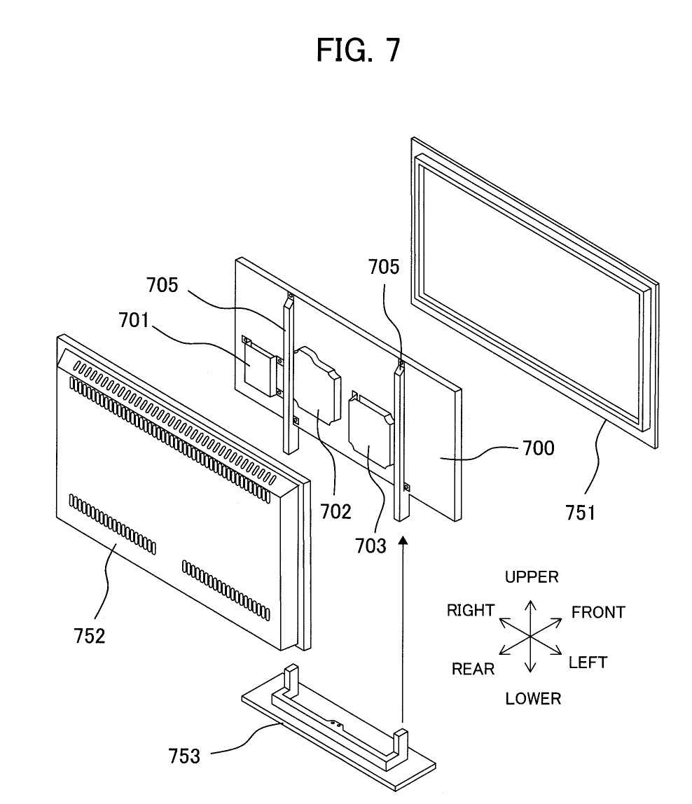

FIG. 7 is a diagram for outlining an example overall structure of the liquid crystal display device according to an embodiment of the present invention.

As described above, the LEDs and light guide plate blocks are arranged on the front side of the chassis 401 (see FIGS. 4 and 5). On the rear side of the chassis 401, circuit boards, not illustrated, including driver circuits for operating the LEDs for backlighting, a signal processing circuit for processing video signals to be supplied to the liquid crystal panel, and a power supply circuit for supplying power to the driver circuits and the signal processing circuit are provided.

As shown in FIG. 7, the sides of the chassis 401 are provided with metallic frames (see FIG. 1) for holding the liquid crystal panel and the backlight device. The mechanical strength of the liquid crystal panel and the backlight device increases by being fixedly held by the metallic frames. The liquid crystal panel and the backlight device held by the metallic frames are entirely covered with a resin or metallic cover to make up a tandem type backlight device and liquid crystal display device.

FIG. 7 is an exploded view of the liquid crystal display device. In FIG. 7, reference numeral 700 denotes a liquid crystal module which includes a liquid crystal panel and a backlight device. The backlight device included in the liquid crystal module is attached to an open side of a frame which is formed of a thin metal plate of, for example, aluminum or iron plate and is shaped like a shallow box with a large bottom area. The reference numeral 401 in FIGS. 4 and 5 denotes a bottom portion of the box-like frame of the chassis.

The liquid crystal module 700 is attached, on its rear side, with a driver board 701 mounted with driver circuits for driving the backlight LEDs, a power supply board 702 mounted with a power supply unit for the liquid crystal display device, a signal processing board 703 mounted with signal processing circuits, and support members 705 for supporting the liquid crystal display device. FIG. 7 also shows a bezel 751, a rear cover 752, and a base 753 to be attached to the support members

According to the above embodiments, longitudinally arranging two light guide plate blocks or one light guide plate block in a horizontal direction makes it possible to reduce the effects of thermal expansion and contraction of the light guide plate block caused by temperature changes on the brightness distribution on the backlight device and the liquid crystal display device, so that the brightness unevenness on them can be reduced.

Even in cases where two light guide plate blocks are longitudinally arranged in a horizontal direction, using a reflection sheet which can cover the rear sides of the two light guide plate blocks makes it possible to reduce the effects of dark lines showing at the boundaries between the two light guide plate blocks on the backlight brightness distribution, so that the brightness unevenness on the backlight device and the liquid crystal display device can be reduced.

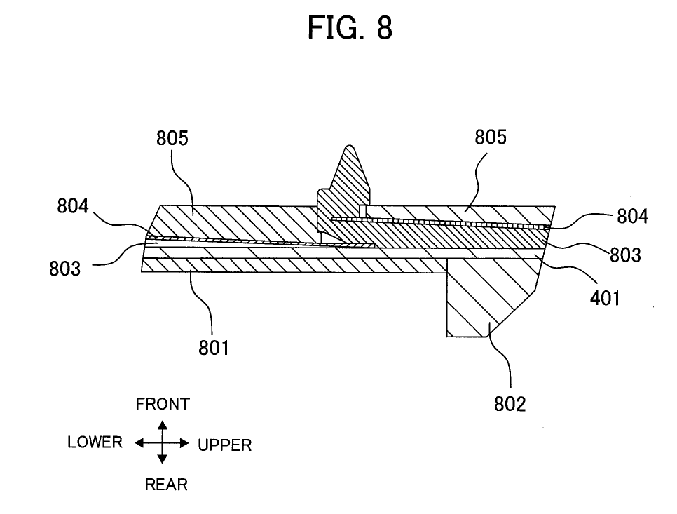

Another embodiment of the present invention will be described below with reference to FIG. 8. FIG. 8 is a partial sectional view of a liquid crystal display device according to the present invention in which the fixing part 405, pin mold 502, and reflection sheet guide 404 shown in FIG. 4 or 5 are combined into an integral structure. In FIG. 8, reference numerals 801 and 802 denote electronic parts mounted on the rear side of the chassis 401; and reference numeral 803 denotes a fixing part integrated with a reflection sheet guide and is formed, for example, by molding a resin. The functions of these parts are the same as described for the foregoing embodiments. The fixing part 803 integrated with the reflection sheet guide is entirely white so as to improve its reflection efficiency.

In the present embodiment, for each light guide plate block, a reflection sheet guide to support the light guide plate block from behind, a fixing part (fixing member) for fixing the light guide plate block provided adjacently below the first mentioned light guide plate block, and a pin mold for supporting a diffusion sheet from behind are integrally formed, for example, by molding a resin. Using the fixing part 803 integrated with a reflection sheet guide makes it possible to reduce the man-hour for fabrication.

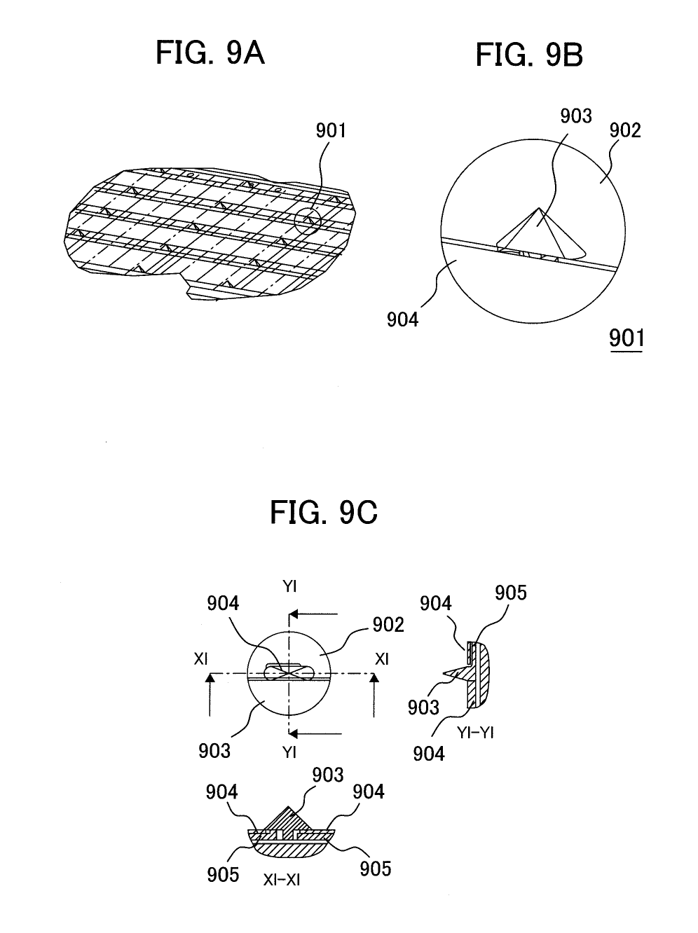

Another embodiment of a fixing part integrated with a reflection sheet guide included in the liquid crystal display device according to the present invention will be described with reference to FIGS. 9A to 9C. FIG. 9A is a partial perspective view of an array of light guide plate blocks in a state detached from a liquid crystal panel. In FIG. 9A, fixing parts 901 which are each integrated with a reflection sheet guide and which each have a projection 903 used to keep a predetermined distance between the liquid crystal panel and the light guide plate blocks are shown. The projections 903, like the pin molds 502 used in the foregoing embodiments, support the diffusion sheet 503 from behind (see FIG. 5). The projections 903 have a white surface like in the foregoing embodiment or are coated with a reflection coating to secure high reflectance.

The projection 903 of the fixing part 901 is shaped like, for example, a slim four-sided pyramid as shown in FIG. 9B. As shown in FIG. 9C, the projection denoted by reference numeral 903 is, in the lateral direction, not in contact with any of the light guide plate blocks 904 and the reflection sheet guides 905 each integrated with a fixing part 901. In the vertical direction, a lower portion of the projection 903 is in contact with the light guide plate block 904 therebelow, but it is not in contact with the light guide plate block 904 thereabove, so that a clearance is formed between it and the light guide plate block 904 thereabove. Also, in the vertical direction, the reflection sheet guide 905 integrated with the fixing part 901 is in contact with the projection 903.

As described above, the projection 903 has a shape which can be easily formed. Even when there is a clearance between two light guide plate blocks laterally arranged side by side, the clearance is covered by the projection 903, so that no dark lines are outputted. This reduces the brightness unevenness on the screen.

In the embodiments shown in FIGS. 8 and 9A to 9C, the fixing part (803 or 901) may have a thin vertical projection or tab which fits a cutout portion provided in the corresponding light guide plate block so as to correctly position the light guide plate block for fixing at a center portion thereof.

Also, in the embodiments shown in FIG. 8 and FIGS. 9A to 9C, the fixing part (803 or 901) may have a reference surface for positioning against the upper end face of the corresponding light guide plate block.

Furthermore, in the embodiments shown in FIG. 8 and FIGS. 9A to 9C, the fixing part (803 or 901) may have a reference surface which allows an upper front surface portion of each light guide plate block and a lower rear surface portion of the corresponding projection to come in mutual contact for positioning of the light guide plate block and the corresponding projection in the front-to-rear direction and the vertical direction, and also for reinforcing the projection.

Even though, in the present embodiment, a reflection sheet guide, a fixing part, and a pin mold are integrally structured, they may be integrated in different manners. For example, a reflection sheet guide and a fixing part may be integrally formed, and a pin mold (projection) may be attached to the integral structure as a discrete part. Or, alternatively, a reflection sheet guide and a pin mold (projection) may be integrally formed, and a fixing part may be attached to the integral structure as a discrete part.

What is claimed is:

1. A liquid crystal display device for displaying an image using a liquid crystal panel, comprising:
a plurality of light sources which are arranged in a horizontal direction to be spaced apart by a predetermined distance and which emit light downwardly;
a plurality of light guide plate blocks to which the light emitted from the plurality of light sources is downwardly incident and which output the incident light to the liquid crystal panel as surface light; and
a chassis which fixes the plurality of light sources and the plurality of light guide plate blocks from behind;
wherein the plurality of light guide plate blocks are arranged along a vertical direction of the liquid crystal display device, each of the plurality of light guide plate blocks having a rectangular shape longitudinally extending along a horizontal direction of the liquid crystal display device; and
wherein each of the plurality of light guide plate blocks is fixed, at a portion thereof corresponding to a center in the horizontal direction of the liquid crystal display device, to the chassis, and a clearance is provided at each end in the horizontal direction of each of the plurality of light guide plate blocks.

2. The liquid crystal display device according to claim 1, wherein each of the plurality of light guide plate blocks is fixed, on an upper side thereof, to the chassis.

3. The liquid crystal display device according to claim 1, wherein the plurality of light guide plate blocks are arranged in an array of one or two vertical columns and a plurality of horizontal rows with a center in the horizontal direction of the one or two vertical columns aligned with the center in the horizontal direction of the liquid crystal display device, the plurality of light guide plate blocks thus arranged making up a light guide plate for outputting the surface light to the liquid crystal panel, each of the plurality of light guide plate blocks having a fixing pin and a fixing part for fixing an upper side thereof to the chassis and being fixed at a portion thereof corresponding to the center in the horizontal direction of the liquid crystal display device.

4. The liquid crystal display device according to claim 1, wherein a rear side of each of the plurality of horizontal rows including the plurality of light guide plate blocks is entirely covered by a reflection sheet.

5. The liquid crystal display device according to claim 4, wherein each of the plurality of light guide plate blocks is fixed, at a portion thereof near one of the plurality of light sources, to the chassis.

6. A liquid crystal display device for displaying an image using a liquid crystal panel, comprising:
a plurality of light sources which are arranged in a horizontal direction to be spaced apart by a predetermined distance and which emit light downwardly;
a plurality of light guide plate blocks to which the light emitted from the plurality of light sources is downwardly incident and which output the incident light as surface light;
a diffusion sheet which diffuses light coming from the plurality of light guide plate blocks and outputs the diffused light to the liquid crystal panel; and
a chassis which fixes the plurality of light sources and the plurality of light guide plate blocks from behind;
wherein the plurality of light guide plate blocks are arranged along a vertical direction of the liquid crystal display device, each of the plurality of light guide plate blocks having a rectangular shape longitudinally extending along a horizontal direction of the liquid crystal display device; and
wherein each of the plurality of light guide plate blocks is provided, on a rear side thereof, with a reflection sheet support member for supporting the light guide plate block from behind, the reflection sheet support member having a projection formed integrally therewith for supporting the diffusion sheet from behind.

7. The liquid crystal display device according to claim 6, wherein each of the reflection sheet support member and the projection is configured to reflect light at a surface thereof.

8. The liquid crystal display device according to claim 6, wherein each of the reflection sheet support member and the projection has a white surface.

9. The liquid crystal display device according to claim 6, wherein the reflection sheet support member further has a fixing part formed integrally therewith for fixing another light guide plate block provided adjacently below the light guide plate block supported by the reflection sheet support member, the fixing part having, on a front side thereof, the projection formed integrally therewith.

10. The liquid crystal display device according to claim 6, wherein the plurality of light guide plate blocks are arranged in two vertical columns arranged side by side in a horizontal direction of the liquid crystal display device.

11. A liquid crystal display device for displaying an image using a liquid crystal panel, comprising:
a plurality of light sources which are arranged in a horizontal direction to be spaced apart by a predetermined distance and which emit light downwardly;
a plurality of light guide plate blocks to which the light emitted from the plurality of light sources is downwardly incident and which output the incident light as surface light;
a diffusion sheet which diffuses light coming from the plurality of light guide plate blocks and outputs the diffused light to the liquid crystal panel; and
a chassis which fixes the plurality of light sources and the plurality of light guide plate blocks from behind;
wherein the plurality of light guide plate blocks are arranged along a vertical direction of the liquid crystal display device, each of the plurality of light guide plate blocks having a rectangular shape longitudinally extending along a horizontal direction of the liquid crystal display device; and
wherein each of the plurality of light guide plate blocks is provided, on a rear side thereof, with a reflection sheet support member for supporting the light guide plate block from behind, the reflection sheet support member having a fixing part formed integrally therewith for fixing another light guide plate block provided adjacently below the light guide plate block supported by the reflection sheet support member.

12. The liquid crystal display device according to claim 11, wherein each of the reflection sheet support member and the projection is configured to reflect light at a surface thereof.

13. The liquid crystal display device according to claim 11, wherein each of the reflection sheet support member and the fixing part has a white surface.

14. The liquid crystal display device according to claim 11, wherein the reflection sheet support member further has a projection formed integrally therewith for supporting the diffusion sheet from behind.

15. The liquid crystal display device according to claim 11, wherein the projection is formed integrally with the fixing part.

16. The liquid crystal display device according to claim 11, wherein the plurality of light guide plate blocks are arranged in two vertical columns arranged side by side in a horizontal direction of the liquid crystal display device.
